(19) United States
(12) Patent Application Publication
(10) Pub. No.: US 2008/0178991 A1
(43) Pub. Date: Jul. 31, 2008

(54) Method of making membrane electrode assemblies

(76) Inventors: Ronald Mah, Burnaby (CA); David S. De Haan, Burnaby (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/698,759

(22) Filed: Jan. 26, 2007

(51) Int. Cl. B32B 37/00

(52) U.S. Cl. 156/182

(57) ABSTRACT

A method of making a membrane electrode assembly includes forming an unbonded membrane electrode assembly and forming a bonding assembly by contacting a first surface of at least one absorbent material against at least one surface of the unbonded membrane electrode assembly, the at least one absorbent material containing a liquid. The membrane electrode assembly includes an anode gas diffusion layer, a cathode gas diffusion layer, an anode catalyst, a cathode catalyst, and a polymer electrolyte membrane interposed between the anode catalyst and the cathode catalyst. The method further includes heating the bonding assembly to effect bonding of at least two components, at least a portion of the liquid being removed.

### CROSS-REFERENCE TO RELATED APPLICATION

This application claims the benefit under 35 U.S.C. § 119(e) of U.S. Provisional Patent Application No. 60/______, filed Jan. 31, 2006 (formerly U.S. application Ser. No. 11/343,963, converted to provisional by petition filed Jan. 17, 2007), which application is incorporated herein by reference in its entirety.

### BACKGROUND OF THE INVENTION

1. Field of the Invention

The present invention relates to method of making membrane electrode assemblies, and more specifically, membrane electrode assemblies with improved adhesion.

2. Description of the Related Art

Electrochemical fuel cells convert fuel and oxidant into electricity. Solid polymer electrochemical fuel cells generally employ a membrane electrode assembly which includes an ion exchange membrane or solid polymer electrolyte disposed between two electrodes, the anode and cathode electrodes typically comprising a layer of porous, electrically conductive material, such as carbon fiber paper or carbon cloth. The membrane electrode assembly comprises a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of membrane electrode assemblies are electrically coupled in series to form a fuel cell stack having a desired power output.

The membrane electrode assembly is typically interposed between two electrically conductive bipolar flow field plates or separator plates, wherein the bipolar flow field plates may comprise of carbonaceous, graphitic, and metallic materials. These bipolar flow field plates act as current collectors, provide support for the electrodes, and provide passages for the reactants and products. Such bipolar flow field plates comprise fluid flow channels to direct the flow of the fuel and oxidant reactant fluids to the anode and cathode electrodes of the membrane electrode assemblies, respectively, and to remove excess reactant fluids and reaction products, such as water formed during fuel cell operation.

Typical methods of making membrane electrode assemblies comprise the steps of applying a layer of catalyst to a gas diffusion layer in the form of an ink or a slurry which contains particulates and dissolved solids mixed in a suitable liquid carrier. The liquid is then removed or evaporated to leave a layer of particulates and dispersed solids on a surface of the gas diffusion layer to form an anode or a cathode electrode. An anode electrode and a cathode electrode are then bonded together with an ion exchange membrane disposed therebetween, typically under heat and pressure, such that the catalyst layers of the electrodes face the ion exchange membrane, to form a membrane electrode assembly. Alternatively, a layer of anode catalyst and cathode catalyst may be coated onto opposing surfaces of the ion exchange membrane to form a catalyst-coated or catalyzed membrane, and then bonded with the porous anode and cathode gas diffusion layers to form a membrane electrode assembly.

It has been discovered, however, that adhesion of the gas diffusion layer to the catalyst layer is not adequate when making membrane electrode assemblies using catalyst-coated membranes. Various methods in the past to solve this problem have been to add an additional adhesive layer, such as a layer of ionomer or mixture of ionomer and conductive particles, such as carbon particles, between the gas diffusion layer and the catalyst layer of the catalyst-coated membrane to improve adhesion. However, this increases cost and complexity in the manufacturing process of membrane electrode assemblies, and may also have an impact on the water management of the fuel cell during operation.

Given these problems, there remains a need to improve the method of making membrane electrode assemblies. The present invention addresses these issues and provides further related advantages.

### BRIEF SUMMARY OF THE INVENTION

In one embodiment of the present invention, an anode gas diffusion layer (hereinafter referred to as “GDL”) is placed adjacent a first surface of polymer electrolyte membrane (hereinafter referred to as “PEM”) such that an anode catalyst is disposed therebetween, and a cathode GDL is placed adjacent an opposing second surface of the PEM such that a cathode catalyst is disposed therebetween, to form an unbonded membrane electrode assembly (hereinafter referred to as “MEA”). Optionally, an adhesive layer may be placed between the unbonded MEA components to improve adhesion thereof.

Prior to bonding, a piece of absorbent material containing a liquid is placed on at least one side of the unbonded MEA to form a bonding assembly. The liquid may be, for example, water, or an organic liquid, or mixtures thereof, and may further contain optional additives, such as a surfactant. The bonding assembly is then heated until at least two of the MEA components are bonded and at least a portion of the liquid is removed from the absorbent material.

In one embodiment, the MEA components may include a catalyst-coated membrane (hereinafter referred to as “CCM”) interposed between the anode GDL and the cathode GDL. Alternatively, the MEA components may include an anode electrode, a cathode electrode, and a PEM interposed therebetween. In another alternative, the MEA components may include a half-CCM, wherein the half-CCM contains one of the anode catalyst and the cathode catalyst.

In a further embodiment, prior to bonding, a venting sheet may be placed against an outside surface of the absorbent material.

In another embodiment, the MEA is additionally subjected to pressure to further effect bonding of the at least two of the MEA components.

In yet further embodiments, a vacuum may be drawn during assembly of the unbonded MEA and/or bonding assembly.

These and other aspects of the invention will be evident from the attached drawings and following detailed description.

### BRIEF DESCRIPTION OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1A is a cross-sectional diagram of a bonded MEA.

FIG. 1B is a cross-sectional diagram of an unbonded MEA with a CCM.

FIG. 1C is a cross-sectional diagram of an unbonded MEA with anode and cathode GDEs.

FIG. 1D is a cross-sectional diagram of an unbonded MEA with a half CCM.

FIG. 2 is a flow chart of the manufacturing process of a MEA.

FIG. 3 is a cross-sectional diagram of an unbonded MEA disposed between two bonding assemblies.

### DETAILED DESCRIPTION OF THE INVENTION

Unless the context requires otherwise, throughout the specification and claims which follow, the word “comprise” and variations thereof, such as “comprises” and “comprising” are to be construed in an open, inclusive sense, that is as “including but not limited to”.

The present invention and method are particularly suitable for solid polymer electrolyte membrane electrode assemblies, though those of ordinary skill in the art will appreciate that they can be employed with other types of MEAs.

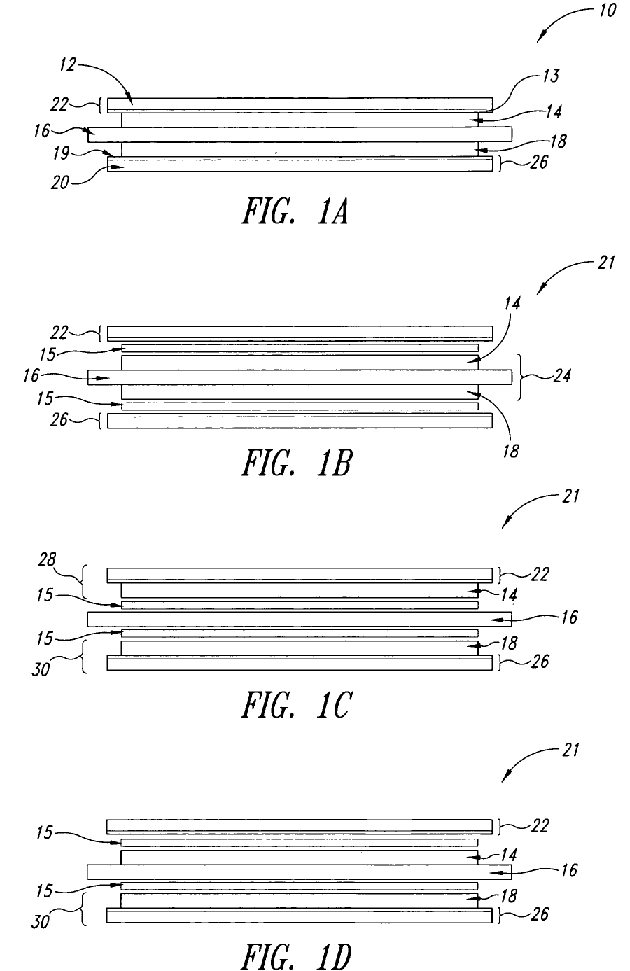

With reference to FIG. 1A, MEA 10 includes an anode GDL 22, an anode catalyst layer 14, a PEM 16, a cathode catalyst layer 18, and a cathode GDL 26. Anode substrate 12 of anode GDL 22 and cathode substrate 20 of cathode GDL 26 are electrically conductive and porous, typically a carbon fiber paper (hereinafter referred to as “CFP”) or carbon cloth that is between 50 and 250 microns thick, to allow efficient electron transfer for electrical energy, improve reactant gas diffusion and distribution to catalyst layers 14, 18, and to remove water during fuel cell operation. Optionally, anode GDL 22 and cathode GDL 26 may comprise anode sublayer 13 and cathode sublayer 19, which may be applied to anode substrate 12 and cathode substrate 20, respectively, in the form of an ink or a slurry of electrically conductive particles, such as carbon particles, dispersed in a suitable liquid, by methods known in the art, such as spraying, knife-coating, screen-printing, and decal-transfer. After application of the sublayers 13, 19, the GDLs 22, 26 are typically dried and/or sintered at an elevated temperature. Additionally, a hydrophobic material, such as polytetrafluoroethylene, may be dispersed in any of anode substrate 12, cathode substrate 20, anode sublayer 13, and cathode sublayer 19 to allow for effective water removal and/or water management during fuel cell operation. Typically, anode sublayer 13 and cathode sublayer 19 contacts anode catalyst layer 14 and cathode catalyst layer 18, respectively, during the assembly of MEA 10.

Anode catalyst layer 14 and cathode catalyst layer 18 may include precious metals, such as platinum, and/or supported catalysts comprising precious metals, such as platinum and ruthenium, or mixtures or alloys thereof, supported on an electrically-conductive support, such as carbon. Anode catalyst layer 14 and cathode catalyst layer 18 may alternatively include a non-noble metal catalyst such as a chalcogenide.

In one embodiment, an unbonded MEA may contain anode and cathode GDLs and a CCM, as shown by unbonded MEA 21 in FIG. 1B. In this example, anode GDL 22 includes anode substrate 12 and anode sublayer 13 while cathode GDL 26 includes cathode substrate 20 and cathode sublayer 19. Anode catalyst layer 14 and cathode catalyst layer 18 may be applied onto opposing surfaces of ion exchange membrane 16 by methods known in the art, such as spraying, screen-printing, and decal-transfer, and other coating methods, to form CCM 24.

Alternatively, anode catalyst layer 14 and cathode catalyst layer 18 may be applied onto a first surface of anode GDL 22 and a first surface of cathode GDL 26, respectively, such that anode catalyst layer 14 contacts anode sublayer 13 and cathode catalyst layer 18 contacts cathode sublayer 19, to form anode GDE 28 and cathode GDE 30, respectively, as shown in FIG. 1C. Again, anode catalyst layer 14 and cathode catalyst layer 18 may be applied onto anode GDL 22 and cathode GDL 26, respectively, by methods known in the art, such as spraying, screen-printing, decal-transfer, and other coating methods.

In a further alternative, only one surface of the ion-exchange membrane contains a catalyst layer, as shown in FIG. 1D. In this example, anode catalyst layer 14 is applied on the first surface of ion exchange membrane 16 to form half CCM 32. When assembling such an MEA, the first surface of anode GDL 22 contacts anode catalyst layer 14 of half CCM 32, and cathode catalyst layer 18 of cathode GDE 30 contacts an opposing second surface of half CCM 32. In this case, the opposing second surface of half CCM 32 does not have catalyst thereon. Alternatively, the above elements are reversed, such that cathode catalyst layer 18 is applied on the opposite surface of ion exchange membrane 16 (not shown).

In FIGS. 1B, 1C and 1D, MEA 21 may optionally include at least one adhesive layer between any of the unbonded MEA components. For example, in FIGS. 1B and 1d, MEA 21 may have at least one adhesive layer 15 between at least one of anode GDL 22 and anode catalyst layer 14 and between cathode GDL 26 and the cathode catalyst layer 18. Alternatively or in combination, MEA 21 may have at least one adhesive layer 15 between anode catalyst layer 14 and PEM 16, and between cathode catalyst layer 18 and PEM 16, as shown in FIGS. 1C and 1D. The at least one adhesive layer 15 may contain polymeric, ionomeric, or conductive materials, or mixtures thereof, to promote adhesion between the unbonded layers. The polymeric materials may be, for example, hydrophobic or hydrophilic, depending on the properties desired. In some cases, an ionomeric material may be desirable to provide the desired water transfer and proton transfer properties through the adhesive layer. These materials may be dissolved in a suitable liquid and applied to the appropriate surfaces, such as a surface of the GDLs, catalyst layers or PEM, prior to the heating step. The at least one adhesive layer may be applied to the various MEA components by any method known in the art, such as spraying, coating, screen-printing, and decal-transfer.

FIG. 2 is a diagram illustrating one example of a bonding assembly. In this example, bonding assembly 40 includes unbonded MEA 21, and at least one absorbent material 38 placed on the outer surfaces of unbonded MEA 21. Absorbent material 38 contains a suitable liquid, such as water, an organic liquid, or mixtures thereof, of anywhere between, for example, 1% and 99% by weight, prior to assembling bonding assembly 40. Optionally, a surfactant may be applied to at least one surface of or impregnated into absorbent material 38 to enhance its absorbent properties.

After assembling bonding assembly 40, bonding assembly 40 is then heated to adhesively bond at least two of the unbonded MEA components and to remove at least a portion of the liquid from absorbent material 38. The bonding temperature should be above ambient temperature, for example, above the boiling point of the liquid, and below the temperature at which the PEM and/or the ionomer degrades, for example below 300° C. Furthermore, the bonding duration should be long enough to remove at least a portion of the liquid from the absorbent material and adhesively bond at least two of the MEA components, for example, instantaneously, for example, 0.1 seconds, and up to 15 minutes.

Without being bound by theory, when bonding assembly 40 is heated, the evaporation of the liquid from absorbent material 38 promotes the adhesion of the unbonded layers with each other. Furthermore, since only absorbent material 38 contains the liquid and is placed adjacent anode GDL 22 and/or cathode GDL 26, PEM 16 does not come into contact with the liquid. Contact of the PEM with the liquid is not desirable because PEM 16 may absorb the liquid, thus resulting in geometrical deformation of the PEM. For example, when the PEM absorbs water, it swells and expands due to water uptake of the ionomer. Thus, if the PEM comes into contact with the liquid when assembling the bonding assembly, it may swell and create wrinkles, which would prevent a substantially smooth bond between the PEM, the catalyst and/or the GDLs.

Optionally, bonding assembly 40 may also be subjected to pressure to further enhance the adhesion between the at least two unbonded MEA components, for example, by placing into a bonding press that may be capable of heating and applying pressure simultaneously. In this case, the bonding pressure should be high enough so that adhesion between the MEA components is enhanced but should not be so high as to damage any of the MEA components, for example, greater than atmospheric pressure and less than 40 bar.

In further embodiments, a vacuum may be applied during assembly of the unbonded MEA and/or bonding assembly. Application of a vacuum in certain embodiments may help with alignment of the MEA components and/or may help prevent wrinkles or folds from forming in the PEM, CCM and/or half-CCM.

As mentioned above, absorbent material 38 may contain any suitable liquid that does not contaminate the MEA, such as water, an organic liquid, or mixtures thereof, and may optionally contain additives, including but not limited to a surfactant. The liquid may be applied to absorbent material 38 by any method known in the art, such as dipping, spraying, and humidifying. If there is an excess amount of liquid in absorbent material 38, the excess may be removed, for example, by squeezing out or evaporating the excess, until absorbent material 38 contains the desired amount of liquid, which may be measured by, for example, its weight gain. The absorbent material may be a carbonaceous, graphitic, or polymeric material, and may be fibrous, porous, and/or microporous in structure. Examples of absorbent materials are carbon fiber paper, carbon cloth, and filter paper. In one embodiment, the liquid may be applied to only one surface of absorbent material 38. In one example, the surface with the liquid may be placed against the outer surface of anode GDL 22 and/or cathode GDL 26 (for example, the surface without the sublayer). In another embodiment, a stack of absorbent materials and/or any thickness of absorbent material may be used. Furthermore, different types of absorbent materials may be used if employing more than one absorbent material on the outer surface of anode GDL 22 and/or cathode GDL 26. In addition, the amount of liquid in absorbent material 38 on the outer surface of anode GDL 22 need not be the same as the amount of liquid in absorbent material 38 on the outer surface of cathode GDL 26, when assembled thereon.

Furthermore, and as shown in FIG. 2, a compliant material 34 and/or a venting sheet 36 may be placed on at least one of the outer surfaces of bonding assembly 40. Compliant material 34 helps even out the bonding pressure and prevents non-uniform bonding of the MEA components in the event that the bonding platens of the bonding press are not perfectly flat. Examples of compliant materials may be expanded graphite and various foams. One example of a compliant material is expanded graphite such as Grafoil®, supplied by Advanced Energy Inc. of Parma, Ohio. In addition, a venting sheet 36 may be placed between compliant material 34 and absorbent material 38. Venting sheet 36 allows for more rapid removal of the liquid from the absorbent material during bonding and may aid in the removal of absorbent material 38 from compliant material 34 after bonding. The venting sheet material may be a carbonaceous, graphitic, or polymeric material, and may be fibrous, porous, and/or microporous in structure. Examples of venting sheet materials are filter paper and peel ply.

One of ordinary skill in the art will recognize that the bonding assembly on the outer surface of anode GDL 22 may include different or different combinations of components (for example, compliant material 34, venting sheet 36, and absorbent material 38) as compared with the bonding assembly on the outer surface of cathode GDL 26. For example, bonding assembly 40 may have at least one of compliant material 34, venting sheet 36 and absorbent material 38 on the outer surface of only anode GDL 22 or cathode GDL 26.

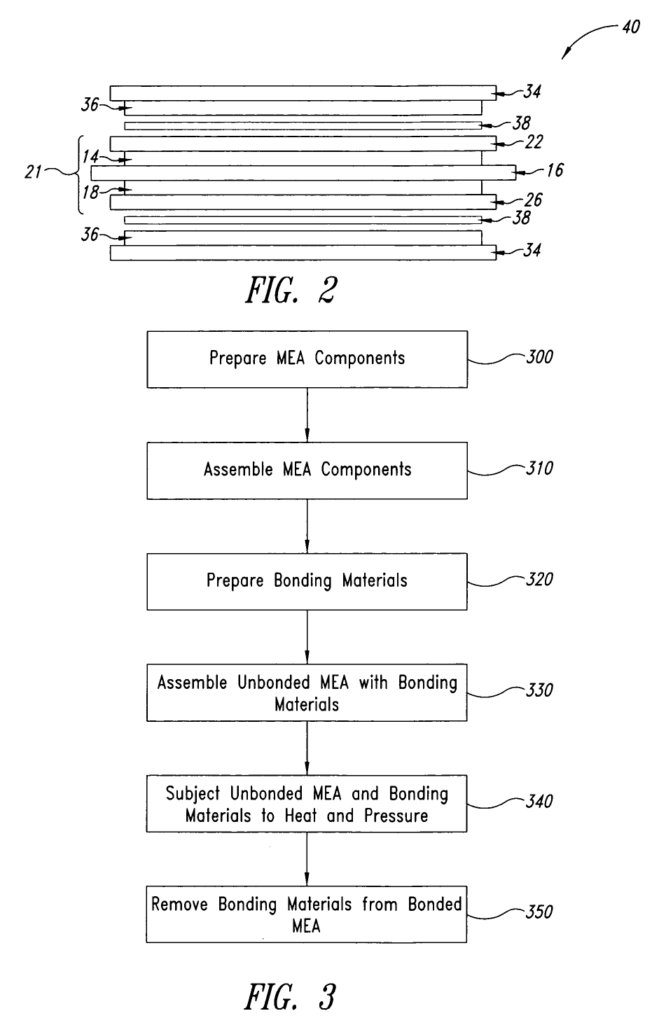

Referring to FIG. 3, a flow chart diagram is presented showing the fabrication of a representative MEA of the present invention.

At block 300, the individual MEA components are prepared, such as those described in the foregoing and shown in FIGS. 1A to 1D.

At block 310, the individual MEA components are assembled into an unbonded MEA such that the anode GDL is in contact with the anode catalyst and the anode catalyst is in contact with the first surface of the PEM, and the cathode GDL is in contact with the cathode catalyst and the cathode catalyst is in contact with the opposing second surface of the PEM. If anode and cathode sublayers are used, they may be situated such that the anode sublayer is located between the anode substrate and the anode catalyst, and the cathode sublayer is located between the cathode substrate and the cathode catalyst. If adhesive layers are employed, they may be disposed between any of the unbonded MEA components. In further embodiments, a vacuum may be drawn during assembly of the unbonded MEA.

At block 320, the bonding materials are prepared. For example, the compliant material and the venting sheet, if using, are assembled such that the venting sheet is placed on top of the compliant material. In one embodiment, two sets of the bonding materials are prepared, one for each side of the MEA. In addition, the absorbent material contains a suitable liquid that is disposed therein by methods known in the art, as described in the foregoing, and then placed onto the surface of the venting sheet. In this example, at least one absorbent material containing a liquid is provided for each set of bonding materials. In further embodiments, a vacuum may be drawn during assembly of the bonding assembly.

At block 330, the unbonded MEA is then disposed between the two sets of bonding materials such that the outer surfaces of the anode and cathode GDLs (for example, the surface facing away from the PEM) contact the absorbent material. The resulting bonding assembly is shown in FIG. 2, which contains compliant material 34, venting sheet 36, and absorbent material 38 on both outer surfaces of unbonded MEA 21.

At block 340, the bonding assembly is then placed in a bonding press at a temperature higher than ambient temperature. The bonding assembly is held in the bonding press until at least two of the MEA components are adhesively attached and at least a portion of the liquid is removed. In a further embodiment, the bonding assembly may be subjected to pressure in addition to temperature, to further enhance the adhesion of at least two of the MEA components.

At block 350, after bonding is complete, the bonding assembly is removed and the non-MEA components, such as the compliant material, the venting sheet, and the absorbent material, are removed from the bonded MEA. By employing this method, no additional adhesive layers are necessary between each of the unbonded MEA components. However, these additional adhesive layers may be used if desired.

One of ordinary skill in the art will appreciate that various combinations of materials may be used for the bonding materials to accommodate variations in the MEA component structures, such as GDEs, CCMs, and half CCMs. For example, the absorbent material may be employed on only either the anode GDL or cathode GDL. In another example, a plurality of venting sheets may be used wherein the venting sheets may be the same or may be different.

Furthermore, this method may also be conducted on a continuous line in a continuous fashion (not shown). For example, rollers at the beginning of the continuous line may be used to continuously supply the anode and cathode GDLs, the CCM, the absorbent material(s), and the venting sheet(s), while rollers at the end of the continuous line moves the bonding assembly along the continuous line and receives the absorbent material(s) and the venting sheet(s). The continuous process may also have spray guns and/or nozzles along the continuous line to disposed the liquid into and/or onto the absorbent material. Bonding may be carried out in a continuous fashion by using heated rollers that contains a compliant material and applies uniform pressure to the bonding assembly as the bonding assembly is fed therethrough, thus instantaneously bonding the MEA components. The continuous MEA may be cut to the desired size after bonding. One of ordinary skill in the art will appreciate the many variations to the continuous process that may be used for continuously producing bonded MEAs and need not be exemplified in further detail.

### EXAMPLES

Five MEAs were prepared using the Gore Series 5510 CCMs supplied by W. L. Gore & Associates, Inc. and the AvCarb™ P50T carbon fiber substrate from Ballard Material Products, Inc. (hereinafter referred to as BMP). The P50T substrates were coated with a slurry of graphitic particles and PTFE to form a sublayer on one surface of the P50T substrate, and then sintered to form GDLs. The unbonded MEAs were then assembled by disposing a CCM between two of the GDLs such that the sublayer of the GDL was in contact with the catalyst on the CCM.

For Trial 1, the unbonded MEA was sandwiched between two pieces of Grafoil®, supplied by AET, with a piece of TGP-H-060 CFP, provided by Toray Industries, Inc., disposed between each surface of the Grafoil® and the P50T substrate, and then bonded at 17.0 bar for 3 minutes at 160° C.

For Trial 2, two sets of bonding materials were prepared by providing two pieces of Grafoil, supplied by AET, placing a piece of Kapton®, provided by E. I. du Pont de Nemours and Co., on each piece of Grafoil, placing a piece of filter paper on each piece of Kapton®, and then placing a piece of peel ply on each piece of filter paper. To prepare the partially saturated absorbent material, two pieces of TGP-H-060 CFP were sprayed uniformly with water such that the substrates contained more than 100% water by weight, and the excess was squeezed out using a squeegee until the substrates were contained 85% water by weight. One piece of the water-containing TGP-H-060 CFP was then placed on each piece of peel ply. The unbonded MEA was then sandwiched between the two sets of bonding materials wherein the outer surfaces of the MEA contacted the water-containing TGP-H-060 CFP. The MEAs were then bonded at 17.0 bar for 3 minutes at 160° C.

Another set of MEAs was prepared with the same GDLs and CCMs. The Trial 3 MEA was made the same way as Trial 1, except that the Trial 3 MEA was bonded at 21.7 bar for 3 minutes at 160° C. Trial 4 MEAs were made the same way as Trial 2 MEAs, except that the Trial 4 MEA was bonded such that only one set of bonding materials contained a piece of water-containing TGP-H-060 CFP (for example, no water-containing TGP-H-060 CFP was employed on the opposing surface of the MEA) and was bonded at 21.7 bar for 3 minutes at 160° C. The Trial 5 MEA was the same as the Trial 2 MEAs, except that the Trial 5 MEA was bonded at 21.7 bar for 3 minutes at 160° C.

All the bonded MEAs were then tested for adhesive strength using Tappi Test Method 541 om-99 entitled “Internal Bond Strength of Paperboard (Z-Direction Tensile)” (herein incorporated by reference). The results are summarized in Table 1.

TABLE 1

| | | Pull | |
|---|---|---|---|
| Trial | Process | Force (N) | Bonding Conditions |
| 1 | Bonded without partially | 64 | 17.0 bar for 3 |
| | saturated substrates | | minutes at 160° C. |
| 2 | Bonded with partially saturated | 123 | 17.0 bar for 3 |
| | substrates | | minutes at 160° C. |
| 3 | Bonded without partially | 11 | 21.7 bar for 3 |
| | saturated substrates | | minutes at 160° C. |
| 4 | Bonded with one partially | 10 | 21.7 bar for 3 |
| | saturated substrate (on one | | minutes at 160° C. |
| | side of MBA only) | | |
| 5 | Bonded with partially saturated | 100 | 21.7 bar for 3 |
| | substrates | | minutes at 160° C. |

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

While particular elements and embodiments have been shown and described, it is not intended to be limited thereto, since modifications may be made by those of ordinary skill in the art without departing from the spirit of the invention and the scope of the present disclosure.

What is claimed is:

1. A method of making a membrane electrode assembly comprising the steps of:
forming an unbonded membrane electrode assembly, the membrane electrode assembly comprising an anode gas diffusion layer, a cathode gas diffusion layer, an anode catalyst, a cathode catalyst, and a polymer electrolyte membrane interposed between the anode catalyst and the cathode catalyst;
forming a bonding assembly by contacting a first surface of at least one absorbent material against at least one surface of the unbonded membrane electrode assembly, and wherein the at least one absorbent material contains a liquid; and
heating the bonding assembly to effect bonding of at least two of the components, wherein at least a portion of the liquid is removed.

2. The method of claim 1 wherein the anode catalyst and the cathode catalyst is bonded to the first surface of the anode gas diffusion layer and the first surface of the cathode gas diffusion layer, respectively, prior to the step of heating the bonding assembly.

3. The method of claim 1 wherein at least one of the anode catalyst and the cathode catalyst is applied to at least one of the first surface of the polymer electrolyte membrane and the opposing second surface of the polymer electrolyte membrane, respectively, prior to the heating step.

4. The method of claim 1 further comprising applying at least one adhesive material between at least one of the anode gas diffusion layer and the anode catalyst, the cathode gas diffusion layer and the cathode catalyst, the first surface of the polymer electrolyte membrane and the anode catalyst, and the second surface of the polymer electrolyte membrane and the cathode catalyst, prior to the heating step.

5. The method of claim 4 wherein the at least one adhesive material comprises an ionomeric material.

6. The method of claim 1 wherein the at least one absorbent material comprises a carbonaceous, graphitic, or polymeric material, or combinations thereof.

7. The method of claim 1 wherein the at least one absorbent material is porous or microporous.

8. The method of claim 1 wherein the at least one absorbent material contains between about 1% and about 99% of liquid by weight.

9. The method of claim 8 wherein the liquid is water.

10. The method of claim 8 wherein the liquid is an organic liquid.

11. The method of claim 8 wherein the liquid comprises water, an organic liquid, or a mixture thereof, and further comprises a surfactant.

12. The method of claim 1 wherein the step of forming the bonding assembly further comprises contacting at least one venting sheet on a second surface of the at least one absorbent material.

13. The method of claim 10 wherein the at least one venting sheet comprises a carbonaceous, graphitic, or polymeric material, or combinations thereof.

14. The method of claim 10 wherein the at least one venting sheet is porous or microporous.

15. The method of claim 1 wherein the heating step occurs at a temperature between about 100° C. and about 300° C.

16. The method of claim 1 wherein the heating step further comprises subjecting the bonding assembly to a pressure of greater than atmospheric pressure.

17. The method of claim 16 wherein the pressure is less than about 40 bar.

18. The method of claim 1 wherein at least one of forming the unbonded membrane electrode assembly and forming the bonding assembly further comprises applying a vacuum.

19. A membrane electrode assembly made by the method of claim 1.
